(19) United States
(12) Patent Application Publication
(10) Pub. No.: US 2020/0190392 A1
(43) Pub. Date: Jun. 18, 2020

(54) CORING FLUID COMPOSITIONS AND METHODS OF USE THEREOF

(71) Applicant: Roger A. Daar, JR., The Woodlands, TX (US)

(72) Inventor: Roger A. Daar, JR., The Woodlands, TX (US)

(21) Appl. No.: 16/708,924

(22) Filed: Dec. 10, 2019

Related U.S. Application Data
(60) Provisional application No. 62/778,473, filed on Dec. 12, 2018.

(51) Int. Cl. C09K 8/52

(52) U.S. Cl. CPC C09K 8/52; C09K 2208/12

(57) ABSTRACT

A composition for use in performing coring operations of boreholes is disclosed. The composition is a mixture of nitrogen gas or carbon dioxide gas, Y-grade fluids mixture and a surfactant foaming agent. In other embodiments, a high density, non-toxic, inert gas compound can be added to the mixture. Alternatively, a flame retardant chemical can be added to the mixture, as well as a gas or chemical additive that alters the mixture's thermal properties.

### BACKGROUND OF THE INVENTION

Conventional fluids used for coring oil and gas wells typically are water-based or water-in-oil emulsion bentonite muds employed in over-balanced pressure operations.

These water-based coring fluids can induce a type of formation damage called “clay swelling”. Clay swelling occurs when clay minerals contained in the core's pore network contact the water in coring fluid via the coring fluid “filtrate” forced into the core as it is cut due to the over-balanced pressure differential employed during coring operation.

After contact with the aqueous filtrate, these swollen clay minerals can occupy a volume several orders of magnitude greater than in their unaltered state. This clay volume expansion reduces rock permeability within the core, the severity of which depends upon filtrate penetration depth, filtrate salinity, contact time between filtrate and clay minerals, and the type of clay minerals. This permeability damaged core contains pore networks with constricted cross-sectional areas which create an additional pressure drop that impedes the flow through the core during laboratory permeability measurements. This increased pressure drop can be interpreted in the lab as a lower permeability than the core's true unaltered magnitude and cascade negative bias into subsequent technical work. Laboratory efforts to restore swollen clays to their original state can result in cores that produce higher permeability measurements than their true unaltered magnitude and cascade positive bias.

Removing water from the coring fluid composition removes the aqueous coring filtrate and the means by which clay minerals swell and block pore throats during coring operations. The compositions of the present invention can inhibit clay swelling, leaving pore network permeability unaltered and delivering cores that produce laboratory permeability measurements closer to their true unaltered magnitudes than had those same cores been cut using conventional water-based coring fluid.

### SUMMARY OF THE INVENTION

In a first embodiment of the invention, the present invention provides for a composition comprising a mixture of nitrogen gas or carbon dioxide gas, Y-grade fluids mixture, and a surfactant foaming agent.

In a second embodiment of the invention, there is disclosed a composition comprising a mixture of nitrogen gas or carbon dioxide gas, Y-grade fluids mixture, a surfactant foaming agent and a high density, non-toxic, inert gas compound.

In a third embodiment of the invention, there is disclosed a composition comprising a mixture of nitrogen gas or carbon dioxide gas, Y-grade fluids mixture, and a flame retardant chemical.

In another embodiment of the invention, there are disclosed improved methods for performing coring operations of boreholes comprising adding the inventive compositions to the boreholes.

In general, Y-grade fluids comprise: ethane, wherein the ethane comprises about 30% to 80% of the fluid; propane, wherein the propane comprises about 15% to 50% of the fluid; butane, wherein the butane comprises about 15% to 45% of the fluid; isobutane, wherein the isobutane comprises about 15% to 40% of the fluid; and pentane plus, wherein the pentane plus comprises about 5% to 25% of the fluid.

The advantages provided by the inventive compositions can inhibit formation damage and the additional pressure drops during laboratory permeability measurements which can occur when coring fluid filtrate invades the pore network of the core during coring operations. Thus the compositions could reduce clay swelling and better retain unaltered core permeability.

The compositions of the present invention would reduce the need to cut cores using expensive water-in-oil emulsion muds and the associated mud disposal requirements. Additionally, the compositions could reduce the need to produce “restored state” cores in the laboratory.

The compositions of the present invention would reduce the deposition of a muddy film on the core surface so that cores do not need to be washed to inspect them at the wellsite.

The compositions of the present invention would be employed in conjunction with under-balanced pressure operations so better rates of core barrel penetration should be achieved.

The inventive compositions can be supplemented by additional components to tune the compositions for specific coring operations.

The inventive composition with the higher density gas component added can provide more reservoir back-pressure and lower the surface foam returns pressure. This could assist in improve safety performance by delivering fewer well “events” during coring operations. The depth and pressure range of reservoirs where foamed coring fluids could be employed could be extended.

The inventive composition can be rendered inert by the addition of flame retardant chemicals thereby improving safety performance. Further, end user perception could also be improved by inerting the flammability of the Y-grade fluids mixture and reducing the Reid Vapor Pressure of the inventive compositions.

### DETAILED DESCRIPTION OF THE INVENTION

The advantages realized by the compositions of the present invention is that they contain no water and no added solid bentonite particles like that of conventional coring fluids.

The inventive compositions can mitigate clay swelling and the formation of muddy films deposited on core surfaces.

This reduction in clay swelling should deliver cores to laboratories with permeabilities closer to their unaltered state. The removal of the muddy film deposited on the core surface should eliminate the need to be wash newly retrieved cores with water at the wellsite in order to inspect them, and thus eliminate the further formation damage caused by this routing practice.

The standard composition as described in the first embodiment can be formulated to provide foam physical properties by adjusting the gas to liquid phase volume ratio or by altering the gas and/or liquid phase compositions. Further, the foam components can be heated or cooled before entering the well. Additional liquid and/or gas phase chemicals or solid phase nanoparticles may also be added to the composition to assist in producing the appropriate core sample.

In the second embodiment, the composition of the first embodiment is supplemented with a compound to increase its density and extend its use into deeper, higher pressure reservoirs. The addition of a high molecular weight gas, such as sulfur hexafluoride, will expand the coring depth capability when the composition is formulated with nitrogen and/or carbon dioxide.

The third embodiment builds from the composition of the first embodiment with the addition of a flame retardant chemical. The addition of flame retardant chemicals will likely improve expected safety performance during coring operations by reducing the Reid Vapor Pressure of the fugitive emissions from the BOP (blow out prevention) stack.

Alternatively, in the third embodiment, the operator of the coring process in a hydrocarbon containing reservoir can have concerns when the pressure is under-balanced during the coring operations. Fugitive hydrocarbon emissions from the BOP (blowout preventer) stacks can create potential fire hazards, so the addition of a flame retardant chemical can assist in the event that there is a fire hazard at the coring site.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

What is claimed is:

1. A composition comprising a mixture of nitrogen gas or carbon dioxide gas, Y-grade fluids mixture, and a surfactant foaming agent.

2. A composition comprising a mixture of nitrogen gas or carbon dioxide gas, Y-grade fluids mixture, a surfactant foaming agent and a high density, non-toxic, inert gas compound.

3. A composition comprising a mixture of nitrogen gas or carbon dioxide gas, Y-grade fluids mixture, and a flame retardant chemical.

4. An improved method for performing coring operations comprising adding a composition selected from the group of mixtures comprising a mixture of nitrogen gas or carbon dioxide gas, Y-grade fluids mixture, and a surfactant foaming agent; nitrogen gas or carbon dioxide gas, Y-grade fluids mixture, a surfactant foaming agent and a high density, non-toxic, inert gas compound; of nitrogen gas or carbon dioxide gas, Y-grade fluids mixture, and a flame retardant chemical; and nitrogen gas or carbon dioxide gas, Y-grade fluids mixture, and a higher quality foam, as well as containing gas and/or chemical additives that alter its thermal properties.
